(19) United States
(12) Patent Application Publication
(10) Pub. No.: US 2007/0093965 A1
(43) Pub. Date: Apr. 26, 2007

(54) Use of infrared thermography in live animals to predict growth efficiency

(76) Inventors: Harry J.S. Harrison, Calgary (CA); Shannon L. Scott, Brandon (CA); Robert J. Christopherson, Edmonton (CA); Alma D. Kennedy, Winnipeg (CA); Alan K. W. Tong, Lacombe (CA); Allan L. Schaefer, Lacombe (CA)

Correspondence Address: GREENLEE WINNER AND SULLIVAN P C, 4875 PEARL EAST CIRCLE, SUITE 200, BOULDER, CO, 80301, US

(21) Appl. No.: 10/558,854

(22) PCT Filed: May 30, 2003
(86) PCT No.: PCT/CA03/00773

§ 371 Date: Sep. 14, 2006

(51) Int. Cl. G06F 19/00; G06G 7/48

(52) U.S. Cl. 702/19; 703/11

(57) ABSTRACT

The invention provides a method for predicting growth efficiency of an animal by using infrared thermography by generating a predictive model, comprising selecting a sample population from a group of animals; scanning each animal to obtain a thermographic image represented as an array of pixels providing temperature data; calculating a value of a statistical measure of the temperature data (input variable); calculating a value of a measure of growth efficiency (output variable); and determining a relationship between the input and output variables to generate a predictive model. The predictive model is then used to predict growth efficiency in an animal from the same group but not in the sample population by scanning the animal to obtain a thermographic image; calculating a value of a statistical measure of the temperature data (input variable); and solving the predictive model to provide the value of the growth efficiency of the animal.

### FIELD OF INVENTION

The invention pertains to a method and apparatus for predicting growth efficiency in live animals using infrared thermography.

### BACKGROUND OF THE INVENTION

Thermoregulation refers to maintenance of body temperature in spite of variations in external conditions such as environmental temperature. The ability of animals or homeotherms to maintain a relatively constant body temperature within a specified range is significant, in that each animal has a preferred range of body temperature within which functioning is optimal. A body temperature outside of the range is generally indicative of disease or extreme environmental conditions. Thermoregulation thus imparts significant advantages to animals, enabling the migration and adaptation of homeotherms in a diversity of environments.

Maintaining a relatively constant body temperature is achieved through balancing heat production by the body and heat loss from the body to the environment. Heat production can be mediated by either voluntary mechanisms (e.g., increasing physical activity, decreasing the amount of skin surface available for heat loss, or moving to a warmer environment) or physiological mechanisms when the animal is in either a steady-state or non-steady state condition. In the steady-state condition, heat production can arise from digestion, muscle activity, blood flow, protein synthesis, non-shivering thermogenesis and oxidative phosphorylation within cells. In the non-steady state condition, heat production can arise from physiological stress, catabolism of tissue, shivering thermogenesis, disease, infection and tumours.

Heat loss can be mediated by either voluntary mechanisms (e.g., decreasing physical activity, increasing the amount of skin surface available for heat loss) or physiological mechanisms when the animal is in either a steady-state or non-steady state condition. Such physiological mechanisms include arterio-venous anastomosis, counter current exchange, vasodilation, vasoconstriction and piloerection. Heat is ultimately dissipated through several means including work, conduction, evaporation, convection, and radiation, with the latter three means directly related to the surface area of the body. However, maintaining a constant body temperature through heat production and heat loss requires procurement and expenditure of energy in the form of food. Typically, homeotherms display a basal metabolic rate, which is the minimum amount of energy which an animal in the resting and fasting state requires to maintain life-sustaining processes such as respiration, circulation, and cellular activity.

Such energy expenditure or metabolic heat production in an animal can be assessed using several techniques. For measurement of the basal metabolic rate, the animal must be within its thermal neutral zone, which is the range of environmental temperatures across which the animal's body temperature can be maintained at its basal metabolic rate. The animal must be in a postabsorptive state, quiescent, in sexual repose, and resting but conscious. Since the latter prerequisite is often difficult to achieve with non-human subjects, the fasting heat production is used for animals which are quiet, but not necessarily resting. Further, in cattle and other ruminants, it is difficult to ascertain when they are in a postabsorptive state. A respiratory quotient (ratio of carbon dioxide produced to oxygen used by the animal) of around 0.7, indicating that the animal is catabolizing fat (normally 48-144 hours after the last meal) is often used as a criterion that the animal is in the postabsorptive state.

Energy expenditure or metabolic heat production can be detected externally by the animal's heat loss pattern. Radiation, through which 40 to 60% of heat is lost from an animal, can be readily measured using any commercially available pyrometer or temperature sensor, since most radiated heat loss can be displayed in the 5-12 μm wavelength range of the electromagnetic spectrum. Direct and indirect calorimetry are further methods for assessing energy expenditure. Direct calorimetry measures heat loss from an animal directly by placing an animal at rest or exercising in a chamber surrounded by a waterjacket. Heat emitted from the animal raises the temperature of the water. The difference in the temperature of water entering and leaving the chamber reflects the animal's energy expenditure. Direct calorimetry tends to be impractical, requiring specialized equipment. Indirect calorimetry measures gas exchange and relates it to heat production. Indirect calorimetry involves monitoring of the amount of oxygen consumed (or conversely, the amount of carbon dioxide produced), and calculating the amount of energy expended by the animal, depending on the food substrate being utilized (e.g., fat, carbohydrate or protein).

However, there may be variation among animals with regard to the efficiency with which they convert food energy to useful forms such as adenosine triphosphate (ATP), the principal energy source for cells to maintain the growth and sustenance of the animal. It has been suggested that the mammalian body, for example, is roughly 40% efficient at converting, food energy to ATP, yet not all of the energy in ATP is then converted to products such as meat or milk (Hegsted, 1974). In a beef cow, it is estimated that 70% of the food energy requirements are simply spent upon maintenance rather than growth of the animal (Ferrell and Jenkins, 1985). Significantly, the variation in this maintenance energy requirement among animals, and even within a species, can be large, ranging from approximately 16-22% (Nielson, 1995). Further, this variation is thought to be due partly to genetic variation in feed efficiency (Archer et al., 1998). There are thus significant differences in feed costs required to produce the same amount of food product from individual animals. Further complicating the matter is that the efficiency of gain in tissue may vary in not only raw efficiencies but also composition or quality (Smith et al., 1992).

Most animal product is currently produced upon an “averages” basis, meaning that producers strive to make profits on the “average” of a pen of animals. However, this system is problematic in that many animals are marketed before (e.g., as in composition) or after (e.g., an excess of fat) a desired end point. A “value-based marketing system” which rewards the production of specific food products and not just animal weight is thus desirable. Such a system, which would enable producers to sort animals based upon efficiency of production, would be advantageous in promoting uniformity of products (e.g., meat or muscle); uniformity and efficiency in meeting animal dietary needs; and efficiency in the utilization of either a physical (e.g., a housing unit or feedlot) or basic resource (e.g., carbon, nitrogen, phosphorus and energy). For producers, the costs of providing feed, supplements or pasture to animals are expensive. Improvement in feed efficiency is thus a significant objective in animal agriculture, in that producers strive to utilize feed resources as efficiently as possible in order to increase profit for an animal product, such as meat or milk.

Feed efficiency refers to the ratio of output to input, or the ratio of gain in an identifiable animal product such as meat or milk (output) to the amount of feed or energy resources required to achieve that gain (input). Feed efficiency can be assessed in several ways. The “feed:gain” or “feed conversion” ratio is simply the kilograms of feed required to achieve a kilogram of gain in an animal product. However, the feed conversion ratio is a gross measure and does not break down feed requirements into sub-components of maintenance and gain. A more informative way of assessing feed efficiency is through growth efficiency, which relates to a unit of growth in an animal product such as body weight, muscle mass, or fat mass per unit of energy input or feed resources consumed (e.g., grain, hay, or feed components such as carbon, nitrogen, calcium, and phosphorus). Growth efficiency also pertains to growth of the live animal or live body weight gain per unit of energy input or feed resources consumed. The accretion of body tissues includes, but is not limited to, protein, lean carcass, inter- or intra-muscular fat, and the accretion of body carbon, nitrogen, calcium or phosphorus. The aforementioned tissues are often represented by the parameters of average fat depth, carcass yield, conformation or body score, cutability, grade fat, lean body mass, lean carcass yield, muscle score, ribeye steak area, and U.S. fat depth.

However, measuring growth efficiency in animals is difficult, requiring tedious progeny testing upon numerous animals and/or measurements of food intake with assessment of loss, storage and work performed to reflect the energy and resource flow through an animal. Ultrasound alone or in combination with body conditioning or frame size scores has been suggested as a means for sorting live animals by efficiency (Brethour, 1990; Forrest, 1995; Basarab et al., 1997). Yet, such procedures are inaccurate, invasive (i.e., require the capture and manipulation of the animal), and tedious. There remains a need for a non-invasive, non-destructive, efficient method capable of sorting live animals into growth efficiency classes.

Infrared thermography is an imaging procedure involving the detection, recording, and production of an image of an animal's surface temperature or thermal patterns, using instruments which can provide immediate visual and quantitative documentation of such temperature measurements. Temperature data are then interpreted using heat loss equations and specialized computer software. Infrared thermography has numerous applications in humans and animals. In humans, infrared thermography has been used for diagnosis of tumours and cardiovascular abnormalities (Clark and Cena, 1972; U.S. Pat. No. 3,245,402 to Barnes); and blood flow related diseases or vascular retinopathies of the eye (U.S. Pat. No. 5,740,809 to Baratta). Further, infrared thermography has been used to study the relationship between metabolic heat production or oxygen consumption and radiated heat loss with both negative and positive findings in surgical and diseased patients (Kvedaras-Golos, 1985; Shuran, 1988). Shuran (1988) suggests that infrared radiation techniques can be used to obtain a measure of energy expenditure and heat loss in humans, although the accuracy may be poor (±20%). In animals, infrared thermography has been used to investigate vascular lesions in pigs and leg injuries in horses (Clark and Cena, 1972); to determine fat content in meat post-mortem (U.S. Pat. No. 3,877,818 to Button et al.); to detect estrous in cattle (U.S. Pat. No. 3,948,249 to Ambrosini); to determine relationships such as weight in the pens of pigs (U.S. Pat. No. 5,474,085 to Hurnik et al.); to identify live animals predisposed to producing poor meat quality (U.S. Pat. No. 5,458,418 to Jones et al.; U.S. Pat. No. 5,595,444 to Tong et al.); and to determine tissue composition characteristics (U.S. Pat. No. 6,123,451 to Schaefer and Tong).

Infrared thermography has a diversity of applications in humans and animals; however, to the inventors' knowledge, use of infrared thermography to predict growth efficiency in live animals has not yet been reported. An accurate, inexpensive and non-invasive system to classify animals according to their growth efficiencies is thus most desirable.

### SUMMARY OF THE INVENTION

The present invention provides a method and apparatus for predicting growth efficiency in live animals using infrared thermography. Growth efficiency relates to a unit of growth in an animal product such as body weight, muscle mass, or fat mass per unit of energy input or feed resources consumed. Growth efficiency also pertains to growth of the live animal or live body weight per unit of energy input or feed resources consumed.

Specifically, the invention provides a method for predicting growth efficiency of an animal by generating a predictive model from a sample population selected from a group of animals, and providing the predictive model to predict growth efficiency in an animal from the same group and not selected for the sample population. Generating a predictive model comprises the steps of:
a) selecting a sample population from a group of animals;
b) scanning each animal in the sample population from at least one view to obtain at least one thermographic image of the animal, whereby each image is represented as an array of pixels providing temperature data representative of temperature information at the corresponding part of the image;
c) calculating a value of at least one statistical measure of the temperature data for each image, wherein the value is treated as an input variable;
d) calculating a value of a measure of growth efficiency of the animal, wherein the value is treated as an output variable; and
e) determining a relationship between the input variable and the output variable to generate a predictive model.

The predictive model is then provided to predict growth efficiency in an animal from the same group and not selected for the sample population, further comprising the steps of:
f) scanning the animal from at least one view to obtain at least one thermographic image of the animal, whereby each image is represented as an array of pixels providing temperature data representative of temperature information at the corresponding part of the image;
g) calculating a value of at least one statistical measure of the temperature data for each image, wherein the value is treated as an input variable; and
h) solving the predictive model to provide the value of the growth efficiency of the animal from the same group and not selected for the sample population.

The predictive model for predicting a relative measure of growth efficiency in an animal is thus illustrated as follows:

$$GE = fn ( 1 / IRTn ) \\ where \text{:} \\ GE = growth efficiency \\ \begin{matrix}IRTn = ( infrared thermographic image mean temperature ° C . ) / \\ ( metabolic body size ) \\ = ( infrared thermographic image mean temperature ° C . ) / \\ {( wt )}^{0.75}\end{matrix} \qquad ( 1 )$$

A further general predictive model for predicting a relative measure of growth efficiency in an animal is illustrated as follows. This model incorporates other input variables including, but not limited to, live weight, gender, breed, temperature cycling, and environmental conditions, which may impact on the prediction of the output variable.

$$\begin{matrix}( ADG / FI ) = fn ( 1 / IRT ) , or & ( 2 ) \\ ADG = fn ( 1 / IRT , FI ) , or & ( 3 ) \\ FI = fn ( IRT , 1 / ADG ) \\ where \text{:} \\ ADG = Average daily weight gain \\ \begin{matrix}FI = Feed intake \\ ( energy input or feed resources consumed )\end{matrix} \\ \begin{matrix}IRT = ( Infrared thermographic image value ) / \\ ( metabolic body size ) \\ = ( IR value ) / {( wt )}^{0.75}\end{matrix} & ( 4 )\end{matrix}$$

The invention further provides an apparatus for predicting the growth efficiency of an animal, with the apparatus comprising:
a) image acquisition means for scanning the animal from at least one view to obtain at least one infrared thermographic image of the animal, whereby each image is represented as an array of pixels providing temperature data representative of temperature information at the corresponding part of the image; and
b) computing and storing means for:
   i) storing each image as an array of pixels providing temperature data representative of temperature information at the corresponding part of the image;
   ii) calculating a value of at least one statistical measure of the temperature data for each thermographic image;
   iii) providing a predictive model according to any one of claims 4-5, whereby growth efficiency is treated as an output variable, and the statistical measure of temperature data is treated as an input variable; and
   iv) solving the predictive model to provide the value of growth efficiency; and,
c) output means for furnishing the value of growth efficiency for the animal.

In further aspects, the invention provides methods for detecting an animal displaying a high growth efficiency; determining an undesirable feed input; selecting a sire or a dam with high growth efficiency; decreasing variation in marketing outcomes by grouping animals with high growth efficiency; utilizing a growing-finishing diet for animals in a group by grouping animals with high growth efficiency; determining a feed input which contributes to growth efficiency in an animal; assessing a group of animals with similar growth efficiencies; and determining differences in animal growth or energy retention-expenditure rates independent of efficiencies.

As used herein and in the claims, the terms and phrases set out below have the meanings which follow:

“Animal” is meant to include domestic ruminant and monogastric animals, including swine (Sus domesticus), horses, cattle (Bos taurus and Bos indicus) and domestic ungulates such as bison, sheep, lamb, deer, moose, elk, caribou and goats; and domesticated fowl, including chickens, turkeys, geese, ducks, game birds, and other birds raised in domestication to produce eggs or meat.

“As-fed basis” means a method of expressing feed composition or the concentration of nutrients in feeds; for example, a hay might be 12 g crude protein per 100 g hay wet weight. The nutrient concentration is determined on the wet weight of the hay, which is the way in which it would be fed to the animal.

“Average fat” means a mathematical average of usually three fat measurements taken along the dorsal surface of the animal measured either on the carcass or by ultrasound.

“Basal metabolic rate” means the minimum or base amount of energy which an animal in the fasting and resting state requires to maintain life-sustaining processes such as respiration, circulation, and cellular activity.

“Carcass yield” means the combined mass of skeletal muscle, bone and associated fat as a proportion of live animal weight. This value is commonly expressed as a percentage (e.g., 60% carcass yield) or as a weight relationship (e.g., 600 g/kg live weight).

“Composition” means the proportion of muscle, fat and bone in an animal.

“Conformation” or “body scores” means the degree of apparent muscling in a live animal. For example, a breeding or genetic company would use a different conformation score for a well finished Limousine breeding bull compared to an under finished Long Horn bull. The conformation score can also be used, for example, by animal herdsmen for comparing the relative fitness or condition of cattle displaying more flesh cover or less flesh cover.

“Cuttability” means the salable yield of a carcass expressed as a proportion of live animal weight.

“Feed efficiency” means the ratio of output to input. In animal production, feed efficiency is the ratio of gain in an identifiable animal product such as meat or milk (output) to the amount of feed or energy resources required to achieve that gain (input). When the animal product is gain in body weight, feed efficiency can also be called growth efficiency.

“Feed conversion” is the inverse of feed efficiency, and is therefore the kg of feed required to achieve a kg of gain in animal product. It is also known as the feed:gain ratio.

“Feed resource” or “energy input” or “feed intake” means feed input such as grain or hay, and feed component inputs such as carbon, nitrogen, calcium, phosphorus or energy. “Grade fat” means the depth (mm) of subcutaneous fat at some repeatable anatomical site along the dorsal surface of the animal. Typically, measurement is made at the 12th rib distal to the atlas vertebrae and approximately 10 cm lateral to the dorsal mid-line. The abattoir or packing company may vary the measurement site. This measure is typically taken either by direct measurement with a ruler on a carcass or also with technology such as an ultrasound probe.

“Growth efficiency” means the unit of growth in an animal product (output) such as body weight or muscle mass or fat mass per unit of feed or energy resources consumed (input). Further, the term is meant to include the growth of the live animal or live body weight gain per unit of feed or energy resources consumed. The accretion of body tissues includes, but is not limited to, protein, lean carcass, inter- or intra-muscular fat, and the accretion of body carbon, nitrogen, calcium or phosphorus. The aforementioned tissues are often represented by the parameters of average fat depth, carcass yield, conformation or body score, cutability, grade fat, lean body mass, lean carcass yield, muscle score, ribeye steak area, and U.S. fat depth.

“Infrared thermographic image” means a scan output of either or both of a visual image and corresponding temperature data. The output from infrared cameras used for infrared thermography typically provides an image comprising a plurality of pixel data points, each pixel providing a temperature data point which can be further processed by computer software to generate for example, mean temperature for the image, or a discrete area of the image, by averaging the data points over a number of pixels.

“Input variables” mean the empirical observations used in a predictive model “Lean body mass” means the total mass of skeletal muscle in an animal. Lean body mass may also be defined as the proportion of the entire live weight of the animal represented by skeletal muscle.

“Lean yield” means the lean yield of muscle expressed as g/kg of cold side weight multiplied by the side weight of cold carcass. Lean yield is equivalent to lean body mass.

“Live weight” means the live weight of an animal pre-slaughter.

“Measure of central tendency” means a statistical measure of a point near the centre of a group of data points. Without limitation, the term includes the mean, median and mode. The mean temperature is the most preferred measure of central tendency used in the present method. For each animal's image, the mean temperature is determined from the average pixel temperature for a discrete area of that animal which has been scanned. The mean temperature determined for each animal's image is the arithmetic mean of the pixel temperature for the discrete area, identified as say the 70×90 pixels of the image in that discrete area.

“Measure of dispersion” is meant to include statistical measures of spread from the measure of central tendency for the group. Preferred measures of dispersion when the measure of central tendency is the mean, include variance, range, standard deviation, coefficient of variation, and standard error. Most preferred is standard deviation.

“Measure of resource inputs” means measure of feed input such as grain or hay, or feed component inputs such as carbon, nitrogen, calcium, phosphorus or energy.

“Metabolic body size” means the body weight in kilograms raised to the 3/4 power or kg⁰⁷⁵. For example, 100 kg of bodyweight raised to the 3/4 power is 31.62 kg^{0.75}.

“Metabolic heat production” or “energy expenditure” means an energetic expression (calories or joules) of the heat produced by an animal. Metabolic heat production can incorporate metabolic body size if it is expressed on the basis of metabolic body size. Heat production is expressed in units of energy, such as calories or Joules (SI unit). When heat production is expressed per unit time, the units are calories per second or Watts (Joules per second, SI unit).

“Metabolism” means chemical changes which utilize energy and result in tissue and compound building (anabolism) or breakdown of substrates and release of energy (catabolism).

“Muscle score” means a mathematical value obtained by making a measurement (ruler or ultrasound measurement) of the rib eye area (typically length and width) on the longissimus dorsi muscle at a fixed anatomical site (again, typically the 12th rib).

“Non-steady state” means a condition in which an animal's endocrine, physiological or metabolic values are in a state of flux often due to environmental factors such as stressors.

“Output variable” means the predictive value or hypothesized value, which is then tested empirically against actual or direct measures of outcome.

“Predictive model” means a predictive outcome or hypothesis which is based on an inductive process requiring empirical observations.

“Rib eye area” means the surface area of a cross section of the longissimus dorsi muscle, typically at the 12th rib. This is usually obtained by either tracing directly onto a sheet of waxed paper and then using a planometer system to elucidate or measure or, alternatively, this is obtained with a mathematical measure of length and width to measure or estimate area in the pig, the comparable measurement is the loin eye area.

“Standard deviation” is the positive square root of the variance for the group, the variance being the arithmetic mean of the squares of the deviations of the individual values from their arithmetic mean.

“Steady-state” means a condition in which an animal's endocrine, physiological and metabolic values are all within a normal range and the animal is not stressed.

“Total temperature” means the mean temperature of an infrared thermographic image× image area expressed as the number of pixels (e.g., if mean temperature=20° C. and the image area=200 pixels, then total temperature=20° C.×200=4000° C.).

“US fat” means a measure of fat depth or quantity (subcutaneous and/or marbling intramuscular fat) commonly used in the US to classify carcasses into categories such as prime, choice, or select. US fat thus denotes both fat thickness and degree of marbling.

### DETAILED DESCRIPTION OF THE INVENTION

The present invention provides a method and apparatus to determine growth efficiency, which pertains to a unit of growth in an animal product such as body weight, muscle mass, or fat mass per unit of energy input or feed resources consumed (e.g., grain, hay, or feed components such as carbon, nitrogen, calcium, and phosphorus). Growth efficiency also pertains to growth of the live animal or live body weight gain per unit of energy input or feed resources consumed. The accretion of body tissues includes, but is not limited to, protein, lean carcass, inter- or intra-muscular fat, and the accretion of body carbon, nitrogen, calcium or phosphorus. The foregoing tissues are often represented by the parameters of average fat, carcass yield, conformation or body score, cutability, grade fat, lean body mass, lean yield, muscle score, rib eye area, and US fat. Specifically, the present invention provides a method and apparatus for predicting the growth efficiency of live animals by using infrared thermography.

The invention provides an apparatus for predicting the growth efficiency of an animal comprising image acquisition means for scanning the animal from at least one view to obtain at least one infrared thermographic image of the animal, whereby each image is represented as an array of pixels providing temperature data representative of temperature information at the corresponding part of the image. Further, the apparatus comprises computing and storing means for storing each image as an array of pixels providing temperature data; calculating a value of at least one statistical measure of the temperature data for each thermographic image; providing a predictive model, whereby growth efficiency is treated as an output variable, and the statistical measure of temperature data is treated as an input variable; and solving the predictive model to provide the value of growth efficiency. The apparatus may also have output means for furnishing the value of growth efficiency for the animal.

Specifically, any standard, commercially available infrared thermographic camera, equipment and related computer software may be used; for example, in the present invention, the infrared camera is the Inframetrics 760 broadband camera fitted with a 0.5× lens (Inframetrics Comp. North Bellercia, Mass.), although any one of several commercially available cameras fitted with different lenses may be used to capture an infrared thermographic image, or a scan output of either or both of a visual image and corresponding temperature data. The output from infrared cameras typically provides an image comprising a plurality of pixel data points, with each pixel providing a temperature data point. Temperature data is then further processed by computer software to generate for example, mean temperature for the image, or a discrete area of the image, by averaging the data points over a number of pixels. Suitable software for analyzing the thermographic images includes Thermogram Image Software (Inframetrics Inc., North Bellercia, Mass.), Viewscan Software (Viewscan Ltd., Concord, ON.), and TIP Image Software (Ottawa, Canada), although any other software capable of analyzing thermographic images may be used. A suitable computer can be any modern PC-compatible computer connected to a standard monitor and a printer to furnish a hardcopy of the data and results.

The invention can be applied to a variety of animal species, but particularly domestic ruminant and monogastric animals, including swine (Sus domesticus), horses, cattle (Bos taurus and Bos indicus) and domestic ungulates such as bison, sheep, lamb, deer, moose, elk, caribou and goats; and domesticated fowl, including chickens, turkeys, geese, ducks, game birds, and other birds raised in domestication to produce eggs or meat. While Example 1 demonstrates the application of the invention in cattle, the invention can be applied to other homeothermic animals.

A sample population of animals is required from a group or pen of animals. The animals in the sample population are preferably of the same species and in sufficient numbers to provide enough data to obtain a statistically significant relationship or correlation among one or more of the selected input and output variables of interest. Such a sample size can contain as few as three animals, more preferably greater than ten animals and most preferably greater than 100 animals. The animals are preferably in a steady state condition, meaning that the animal's endocrine, physiological and metabolic values are all within a normal range and the animal is not stressed. Since stressed animals may display endocrine, physiological or metabolic values which are in a state of flux due to environmental factors, such“non-steady state” animals are excluded from the sample population, since abnormal thermal expression (e.g., due to infection) may interfere with the collection of data suitable for making the predictive model of the invention. Further, since the invention relates to prediction of growth efficiency, the animals are preferably in a growing phase of life, as opposed to a finishing stage or period when growth has reached a plateau.

The invention thus provides a method for predicting the growth efficiency of live animals using infrared thermography by generating a predictive model from a sample population selected from a group of animals, and providing the predictive model to predict growth efficiency in an animal from the same group and not selected for the sample population. Briefly, generating a predictive model comprises the steps of:
a) selecting a sample population from a group of animals;
b) scanning each animal in the sample population from at least one view to obtain at least one thermographic image of the animal, whereby each image is represented as an array of pixels providing temperature data representative of temperature information at the corresponding part of the image;
c) calculating a value of at least one statistical measure of the temperature data for each image, wherein the value is treated as an input variable;
d) calculating a value of a measure of growth efficiency of the animal, wherein the value is treated as an output variable; and
e) determining a relationship between the input variable and the output variable to generate a predictive model.

The predictive model is then provided to predict growth efficiency in an animal from the same group and not selected for the sample population, further comprising the steps of:
f) scanning the animal from at least one view to obtain at least one thermographic image of the animal, whereby each image is represented as an array of pixels providing temperature data representative of temperature information at the corresponding part of the image;
g) calculating a value of at least one statistical measure of the temperature data for each image, wherein the value is treated as an input variable; and
h) solving the predictive model to provide the value of the growth efficiency of the animal from the same group and not selected for the sample population.

Initially, a sample population of at least three, more preferably greater than ten, and most preferably greater than 100 live animals is drawn from a group or pen of animals. Each animal in the sample population is then scanned from a distance of approximately 1 to 3 metres using the infrared camera to generate at least one or more infrared thermographic images. The preferred distance is approximately 175-185 cm. The animal can be scanned from several different views including, but not limited to, the dorsal (top), lateral (side), distal (rear), ventral (bottom or belly) and proximal (front) views of the animal, although the dorsal (top) side is preferred. The images can include the entire animal or portions thereof (e.g., facial areas). Images from the views can be taken of each animal both before slaughter, and of each animal carcass within approximately 24 hours after slaughter.

Each obtained infrared thermographic image comprises a plurality of pixel data points (typically 135×256 pixels) with each pixel providing a temperature data point representative of temperature information at the corresponding part of the image. The relative radiant surface temperature corresponding to each pixel may be represented by assigning each pixel a numerical value in the range from 0 to 255 for example. The pixel values are mapped to actual Celsius temperatures by relating them to the maximum and minimum temperature settings of the infrared camera using the following formula:

$$Actual Temperature = \frac{\begin{matrix}( maximum temperature setting for camera ) - \\ ( minimum temperature setting for camera )\end{matrix}}{256} \times ( Pixel value for the pixel ) \qquad ( 5 )$$

While much of the statistical analysis is computer-generated, pixel values can be assigned specific color values for displaying the images visually on a computer monitor and“illustrating” the collected data; for example, purple may identify pixels representing temperatures less than 16° C., blue for temperatures from 16 to 19° C., and light blue for temperatures from 19 to 21° C. The whole image or a portion thereof may be selected for further analysis.

Each temperature data point is then further processed by computer software to generate the value of at least one statistical measure; for example, the mean temperature for the entire image, or a portion thereof by averaging the data points over the number of pixels. Such values serve as data for each of the input variables used in the predictive model.

Statistical measures comprise measures of central tendency, dispersion, or total temperature. The measure of central tendency is selected from the mean, median, or mode or a non-parametric or rank-scale value, with the preferred measures being the mean, median and mode. The measures of dispersion can include, but are not limited to, the variance, range, standard deviation, coefficient of variation, and standard error. Total temperature relates to the mean temperature of an infrared image multiplied by the image area which is expressed in pixels.

The input variable in the present invention is thus temperature; however, other input variables, which represent animal properties not derived from the infrared thermography, may be selected and included in the predictive model. Such input variables may include, but are not limited to, live weight, compositional data (e.g., proportion of muscle, fat, and bone in the animal), feed consumption, and sex of the animal. Input variables can be used from both the live animal and carcass. Carcass measurements which can also be included as input variables in the predictive model include, but are not limited to, average fat, carcass yield, conformation or body scores, cuttability, grade fat, lean body mass, lean yield, muscle score, rib eye area, and US fat. Standardized procedures for measuring these various physical characteristics of a live animal or carcass are well known to those skilled in the art. The output variable in the present invention is growth efficiency but can include any additional variables including, but not limited to, quantity of accumulated tissue or quantity of feed resource or energy input.

Using this collected data, a relationship between the input variables and output variables is determined to generate a predictive model. Any number of known statistical techniques (including, but not limited to, multiple linear regression, cluster analysis, discriminate analysis, curve fitting, ranking and artificial neural network learning) may be used in order to determine the relationship between the input variables and the output variables to arrive at a predictive model.

Once the predictive model has been generated, a value for the output variable (e.g., growth efficiency) can be predicted for other animals in the group or pen of animals from which the initial sample population was drawn. An animal from the same group but which was not included in the sample population is scanned by infrared thermography from at least one view to obtain at least one infrared thermographic image of the animal, whereby each image is represented as an array of pixels providing temperature data representative of temperature information at the corresponding part of the image. The temperature data is then processed to generate a value of at least one statistical measure, wherein the value is treated as an input variable. This value and data from other input variables are entered into the predictive model, which is then solved to provide the value of growth efficiency (output variable) of the animal.

In the present invention, the relationship is thus determined between the input variable, namely the statistical measures for the thermographic images, and the output variable, namely growth efficiency expressed as tissue accumulated per unit of feed resource or energy input. A general predictive model for predicting a relative measure of growth efficiency in an animal is thus illustrated as follows. This predictive model does not account for the potential impact of other variables including, but not limited to, live weight, gender, breed, temperature cycling and environmental conditions on the prediction of the output variable.

$$GE = fn ( 1 / IRTn ) \\ where \text{:} \\ GE = growth efficiency \\ \begin{matrix}IRTn = ( infrared thermographic image mean temperature ° C . ) / \\ ( metabolic body size ) \\ = ( infrared thermographic image mean temperature ° C . ) / \\ {( wt )}^{0.75}\end{matrix} \qquad ( 1 )$$

A further general predictive model for predicting a relative measure of growth efficiency in an animal is illustrated as follows. This model incorporates other input variables including, but not limited to, live weight, gender, breed, temperature cycling, and environmental conditions, which may impact on the prediction of the output variable.

$$\begin{matrix}( ADG / FI ) = fn ( 1 / IRT ) , or & ( 2 ) \\ ADG = fn ( 1 / IRT , FI ) , or & ( 3 ) \\ FI = fn ( IRT , 1 / ADG ) \\ where \text{:} \\ ADG = Average daily weight gain \\ \begin{matrix}FI = Feed intake \\ ( energy input or feed resources consumed )\end{matrix} \\ \begin{matrix}IRT = ( Infrared thermographic image value ) / \\ ( metabolic body size ) \\ = ( IR value ) / {( wt )}^{0.75}\end{matrix} & ( 4 )\end{matrix}$$

Metabolic body size is used in all of the above predictive models, and is expressed as the body weight in kilograms raised to the 3/4 power or kg^{0.75.} For example, 100 kg of bodyweight raised to the 3/4 power is 31.62 kg^{0.75}. Since the live weight of an animal varies, the metabolic body size of the animal is used to provide a standard basis upon which to express energy expenditure or metabolic heat production, which is detected by infrared thermography. As indicated by both predictive models, animals with a higher IRT value utilize more energy or feed resources to obtain the same growth rate as those animals with a lower IRT value and therefore exhibit a reduced growth efficiency.

Example 1 demonstrates the model which predicts a relative measure of growth efficiency in an animal but incorporates other input variables, namely environmental conditions (cold and warmth) which may impact on the prediction of the output variable. The objectives were thus to determine whether infrared thermography could be used to predict growth efficiency, and to use infrared thermography to identify and classify animals which exhibit more efficient growth compared to that of other animals. Crossbred heifers were randomly allocated to one of two treatment groups and acclimatized to either a cold or warm environment. Data for metabolic heat production or food energy expenditure were obtained using infrared thermography as described above and indirect calorimetry, which measures gas exchange and relates it to heat production. Indirect calorimetry involves monitoring of the amount of oxygen consumed (or conversely, the amount of carbon dioxide produced), and calculating the amount of energy expended by the animal, depending on the food substrate being utilized (e.g., fat, carbohydrate or protein). Data from other input variables including live weight, feed intake (energy input or feed resources consumed), and carcass yield were also collected to generate the predictive model. Carcass yield pertains to the combined mass of skeletal muscle, bone and associated fat as a proportion of live weight of the animal. This value is commonly expressed as a percentage (e.g., 60% carcass yield) or as a weight relationship (e.g., 600 g/kg live weight).

The invention thus provides a predictive model which can be used to indicate which specific types of resource inputs (e.g., diet types) contribute to high growth efficiency. The specific resource input and growth efficiency values used in a given situation may depend upon such factors as the ease of measurement and utility of the value to the group concerned.

The invention is applicable to a broad variety of other tasks pertaining to animals. In another application, the invention provides a means to identify individual animals with differences in growth rates independent of efficiencies. Such an embodiment can be advantageous in that if animal input costs (e.g., feed) were notably inexpensive, it is economically feasible to raise or select for animals that grow rapidly irrespective of input resources such as feed.

Further, the invention can be used to assess a group or pen of animals having similar growth efficiencies, particularly in order to reduce variation in marketing outcomes. The production of animals with similar growth patterns could be expressed as less variation in animal traits (e.g., carcass yield) and in the efficiency of diet utilization. This is specifically applicable to the efficient use of a growth finishing diet for animals in a group.

The invention further provides a process for using infrared thermography data and efficiency calculations for selecting sires and dams for breeding purposes, as used in genetic selection programs.

Further, the invention provides a predictive model which can be used to produce a reciprocal value for growth efficiency. The ability to predict the diets or conditions which are deleterious to the animal's growth is desirable. The invention can be applied to monitoring and controlling weight gain in breeding and show animals, preferably poultry in that heavy broiler toms and roosters often become too heavy to breed.

The invention is further illustrated by the following non-limiting example.

### Example 1

### Effect of Environmentally Induced Changes in Metabolic Heat Production and Growth Efficiency

Animals and Housing

Eighteen yearling crossbred heifers of approximately 370 kg body weight raised at the Agriculture and Agri-Food Canada Lacombe Research Centre (Lacombe, Alberta, Canada) were used for the study. The animals were housed in appropriate environmental chambers (Metabolic Laboratory, Department of Agricultural Food and Nutritional Sciences, University of Alberta, Edmonton, Canada). The feed consisted of balanced pelleted alfalfa based ration consisting of 88.7% dry matter, 2.87 MJ NE/kg with 12% crude protein (values expressed on an as-fed basis). The ration also contained 0.02% Rumensin™ to prevent bloating and 0.025% MGA® (a synthetic estrogen) to prevent estrus during the experiment.

Procedure

The animals were randomly allocated to one of two treatment groups, with 9 animals in each group. The treatments were as follows:
a) Cold ad libitum (CAL), whereby the animals were conditioned to −18° C. for three weeks in the environmental chambers and fed pelleted feed ad libitum; and
b) Warm add libitum (WAL), whereby the animals were exposed to 18° C. for three weeks in the environmental chambers and fed pelleted feed ad libitum.

All animals were placed into the appropriate environmental chambers and adapted to their respective environments for 21 days. During this time, the photoperiod was kept constant at 12 h light and 12 h dark. The animals were trained to wear face masks which were used to monitor respiratory gases for indirect calorimetry (Young, 1975). Indirect calorimetry measurements were taken on day 22 of the study in a thermoneutral environment. Data for live weights and feed intake (energy input or feed resources consumed) of the animals were also determined. All animals were scanned using an infrared camera (Inframetrics model 760 with a 0.5× lens). Scans were obtained from dorsal, lateral and distal views of the live animals at a distance of approximately 175 cm. TIP image software (Ottawa, Canada) was used for the subsequent analysis of the thermographic images.

The animals were then transported to the research abattoir at the Agriculture and Agri-Food Canada Lacombe Research Centre (Lacombe, Alberta, Canada) and slaughtered. Thermographic scans were obtained of the carcasses of the animals from the lateral view approximately one hour after slaughter. The carcasses were analyzed for compositional measurements (e.g., carcass yield, lean body mass, and others) according to the method of Jones et al. (1992).

The image area and values for temperature statistics including the mean, median, and mode as well as the total temperature (mean temperature of an infrared thermographic image× image area expressed as the number of pixels) were calculated for each of the infrared images. The relationship between the input variable (i.e., the statistical measures for the thermographic images) and the output variable (i.e., growth efficiency expressed as tissue accumulated per unit of feed resource or energy input) was then determined using standard statistical analyses such as the Students T test, regression-correlation techniques, and the Spearman ranking test (Daniel, 1983).

Briefly, the Spearman rank correlation coefficient (rₛ) is a nonparametric measure of correlation which measures the degree of correlation between the sample values of X and Y, namely the independent and continuous variables of a bivariate distribution. The hypotheses tested were the following:
(a) HO (null hypothesis): X and Y are mutually independent (i.e., no correlation between them)
   H_{A} (test hypothesis): there is a tendency for large values for both X and Y to be paired together (i.e., direct correlation between them)
(b) H_{O} (null hypothesis): X and Y are mutually independent (i.e., no correlation between them)
H_{A} (test hypothesis): there is a tendency for large values of X to be paired with small values of Y (i.e., inverse correlation between them)
To calculate the Spearman rank correlation coefficient (rₛ), the values of X are ranked from 1 to n (the number of pairs of values of X and Y in the sample), and the values of Y are ranked from 1 to n. The difference (d) between the rank of X and the rank of Y is determined for each pair, and these differences are incorporated into the formula used to calculate rₛ as follows:

$${r}_{s} = \frac{1 - 6 \sum {d}^{2}}{{n}^{3} - n} \qquad ( 6 )$$

A one-sided test is used to test the above hypotheses. Rejection of the null hypothesis means there is a significant correlation (direct or inverse) between the variables X and Y.
Results

Results are presented in Table 1. Initially, there were 9 animals per treatment group which were fed ad libitum. However, the number of test animals producing data was reduced to 8 animals in the WAL group and 5 animals in the CAL group due to missing feed intake data and animals displaying negative growth. The normalized metabolic heat production (MHPn) is calculated as follows and expressed as megajoules/kg metabolic body size (kg^{0.75}) per day:
MHPn=Metabolic heat production/Metabolic body size (7)
The normalized infrared thermographic image value (IRTn) is calculated as follows and expressed as infrared thermographic image mean temperature (° C.) per kg metabolic body size (kg^{0.75}):
IRTn=Infrared thermographic image value/Metabolic body size (8)
Average daily gain (ADG, expressed in kg) was based on an average over 25 days, while feed intake (kg) was based on an average of over 23 days. The relationships among the input variables (i.e., metabolic heat production, and the statistical measures for the thermographic images) and the output variable (i.e., growth efficiency expressed as tissue accumulated per unit of feed resource or energy input) was then determined using regression-correlation techniques and the Spearman ranking test.

The correlation coefficient (r) as determined by the Pearson Correlation Coefficient method (Daniel, 1983) was determined to measure the degree of linear relationship between IRTn and ADG. The correlation coefficient is a number between −1 and 1 which measures the degree to which two variables are linearly related. A correlation coefficient of 1 represents a positive correlation or perfect linear relationship between the two variables, whereby all points in a scatter diagram would lie on a straight line rising upward to the right. A correlation coefficient of −1 represents a perfect linear relationship with negative slope between the two variables (i.e., when one variable has a high (low) value, the other has a low (high) value). All points in a scatter diagram would lie on a straight line falling downward to the right. Any value of r in the vicinity of +1 or −1 implies that the points are scattered closely around a straight line. A correlation coefficient of 0 means that there is no linear relationship between the variables. The correlation coefficient for IRTn vs ADG was 0.7, indicating a strong association between the two variables. The slope was negative at −0.70, indicating an inverse relationship between the two variables.

The Spearman ranking test was used to examine the relationships among metabolic heat production, infrared thermography, and growth efficiency using the collected data from 8 animals in the WAL group and 5 animals in the CAL group. A significant direct relationship was found between IRTn and MHPn. Infrared thermography detects the surface temperature or thermal patterns of an animal; thus, high metabolic heat production in an animal was expected to generate correspondingly high infrared thermographic image values.

ADG showed significant inverse relationships with both IRTn and MHPn, in that high ADG values ranked significantly with both low IRTn and low MHPn values. Metabolic heat production normally arises from the expenditure of energy in the form of food. Storage of energy input or a feed resource in the body is reflected by a gain in body weight. Since the energy input is stored rather than catabolized (i.e., substrates are broken down, energy is utilized, hence heat is released), the metabolic heat production is low; thus, infrared thermographic image values are correspondingly low.

Feed efficiency for all animals showed a significant inverse relationship with IRTn, in that high feed efficiency values ranked significantly with low IRTn values. Animals with high feed efficiency thus produce less heat or expend less energy as indicated by low IRTn values.

Turning to the specific treatment groups, both the WAL and CAL groups received the same amount of energy input or feed resources (represented by feed intake). However, the average daily gain of the CAL group was lower than that of the WAL group, indicating that the feed intake in the CAL group was not stored but catabolized. Animals (WAL group) with high feed efficiency produced less heat (i.e., expended less energy or feed intake) as indicated by low IRTn values. In comparison, animals (CAL group) with a lower feed efficiency produced more heat (i.e, expended more energy or feed intake) as indicated by the higher IRTn values. Animals with a higher IRT value thus need to utilize more energy or feed resources in attempt to obtain the same growth rate as those animals with a lower IRT value, and therefore exhibit a reduced growth efficiency. These results were thus used to derive the general predictive models as previously discussed (see formulae 1-4).

TABLE 1
Relationships among metabolic heat production, infrared thermography, and growth efficiency

| | | Normalized Metabolic | Normalized Infrared | | | | |
|---|---|---|---|---|---|---|---|
| | | Heat Production | Thermographic image value | | | | |
| | Number | (MHPn) | (IRTn) | Number | | | |
| | of test | (Metabolic Heat | (Infrared | of test | Average Daily | Feed intake, | Feed |
| | animals | Production/Metabolic | Thermographic image | animals | Gain, kg | kg | Efficiency |
| Treatment | (n) | Body Size) | value/Metabolic Body Size) | (n) | (ADG) | (FI) | (ADG/FI) |
| Warm | 9 | 0.558 a | 0.369 a | 8 | 0.656 | 12.78 a | 0.048 a |
| (18° C.) | | | | | | | |
| (WAL) | | | | | | | |
| Cold (−18° C.) | 9 | 0.650 b | 0.416 b | 5 | 0.394 | 17.14 a | 0.023 b |
| (CAL) | | | | | | | |
| Significance | | 2 tail P = 0.038 | 2 tail P = 0.08 | | 1 tail P = 0.167 | 1 tail P = 0.167 | 1 tail P = 0.067 |
| | | | 1 tail P = 0.04 | | 2 tail P = 0.27 | 1 tail P = 0.27 | 2 tail P = 0.13 |

a, b means with different letters within columns are significantly different
Statistical Calculations
Correlation Coefficient IRTn vs ADG = −0.70 and r = 0.7
Spearman Ranking Test:
1. ADG and IRTn = High ADG value ranks significantly with low IRTn value (P < 0.01)
2. ADG and MHPn = High ADG value ranks significantly with low MHPn value (P < 0.01)
3. IRTn and MHPn = Low (or high) IRTn value ranks significantly with low (or high) MHPn value (P < 0.01)
4. High feed efficiency for all animals is significantly ranked with low IRTn (P < 0.05).

### REFERENCES

Archer, J. A.; Authur, P. F.; Herd, R. M. and Richardson, E. C. (1998) Genetic variation in feed efficiency and its component traits. Proc. ₆^{th} World Congr. Gen. Applied to Livestock Prod. 25: 81-84.
Basarab, J. A.; Miligan, D.; McKinnon, J. J. and Thorlakson, B. E. (1997) Potential use of video imaging and real time ultrasound on incoming feeder steers to improve carcass uniformity. Can. J Anim. Sci. 77: 385-392.
Brethour, J. R. (1990) Relationship of steer feedlot performance to ultrasound measured backfat thickness. Kansas State Agricultural Experimental Reports of Progress 597, P31.
Clark, J. A. and Cena, K. (1972) Thermographic measurements of the surface temperatures of animals. J. of Mammalogy 54: 1003-1007.
Daniel, W. W. (1983) Biostatistics: A Foundation for Analysis in the Health Sciences. John Wiley and Sons Ltd., Toronto, ON, pp. 421-427.
Ferrell, C. L. and Jenkins, T. G. (1985) Cow type and nutritional environment: nutritional aspects. J. Anim. Sci 61: 725-741.
Forrest, J. C. (1995) New techniques for estimation of carcass composition. p. 157-171. In S. D.

Morgan Jones. Quality and Grading of Carcasses of Meat Animals. CRC Press Inc. Boca Raton, La.
Hegsted, D. M. (1974) Energy needs and energy utilization. Nutr. Rev. 33: 33-38.
Jones, S. D. M., A. L. Schaefer and A. K. W. Tong (1992) The effects of fasting, electrolyte supplementation and electrical stimulation on carcass yield and meat quality in bulls. Can. J Anim. Sci. 72: 791-798.
Kvedaras-Golos, K. A. (1985) Development of Infrared Thermography as a Tool to Quantitate Heat Loss in Humans. MSc. Thesis. University of Illinois. Urbana-Champaign, Ill.
Nielson, M. K. (1995) Genetic variation in feed intake: evidence and questions. In Workshop on Beef Cattle Energetics, pp. 89-95. November 1-3. Denver, Colo.
Shuran, M. (1988) Direct Quantitation of Heat Loss in Human Subjects Using Infrared Thermography. PhD. Thesis. University of Illinois. Urbana-Champaign, Ill.
Smith, G. C. et al. (1992) Improving the consistency and competitiveness of beef. Final report of the National Beef Quality Audit. 1991. National Cattlemen's Beef Association.

Englewood, Colo.
Young, B. A. (1975) Temperature induced changes in metabolism and body weight of cattle (Bos taurus). Can. J. Physiol. Pharmacol. 53: 947-953.

### Patent Documents

Ambrosini, H. J. Method and apparatus for detecting and identifying a cow in heat. U.S. Pat. No. 3,948,249, issued Apr. 6, 1976.
Baratta, F. I. Noninvasive infrared blood flow detector. U.S. Pat. No. 5,740,809, issued Apr. 21, 1998.
Barnes, R. B. Process of diagnosis by infrared thermography. U.S. Pat. No. 3,245,402, issued Apr. 12, 1966.
Button, G. F. and Norris, K. H. Photo-optical method for determining fat composition in meat. U.S. Pat. No. 3,877,818, issued Apr. 15, 1975.
Hurnik, D.; Ireland, W. P.; Stahlbaum, B. W.; Dawson, W. E. Remote thermographic sensing of livestock. U.S. Pat. No. 5,474,085, issued Dec. 12, 1995.
Jones, S. D. M.; Schaefer, A. L.; Tong, A. K.; Scott; S. L.; Gariepy, C. D. J.; Graham, R. C. Method for detecting poor meat quality in live animals. U.S. Pat. No. 5,458,418, issued Oct. 17, 1995.
Schaefer, A. L. and Tong, A. K. Process for determining a tissue composition characteristic of an animal. U.S. Pat. No. 6,123,451, issued Sep. 26, 2000.
Tong, A. K., Jones, S. D. M. and Schaefer, A. L. Method for detecting poor meat quality in groups of live animals. U.S. Pat. No. 5,595,444, issued Jan. 21, 1997.

All publications mentioned in this specification are indicative of the level of skill in the art to which this invention pertains. To the extent they are consistent herewith, all publications mentioned in this specification are herein incorporated by reference to the same extent as if each individual publication was specifically and individually indicated to be incorporated by reference. No admission is made that any cited reference constitutes prior art.

1. A method for determining a measure of growth efficiency of an animal comprising generating a predictive model from a sample population selected from a group of animals, and providing the predictive model to predict growth efficiency in an animal from the same group and not selected for the sample population.

2. The method according to claim 1, wherein generating a predictive model comprises the steps of:
a) selecting a sample population from a group of animals;
b) scanning each animal in the sample population from at least one view to obtain at least one thermographic image of the animal, whereby each image is represented as an array of pixels providing temperature data representative of temperature information at the corresponding part of the image;
c) calculating a value of at least one statistical measure of the temperature data for each image, wherein the value is treated as an input variable;
d) calculating a value of a measure of growth efficiency of the animal, wherein the value is treated as an output variable; and
e) determining a relationship between the input variable and the output variable to generate a predictive model.

3. The method according to claim 2, wherein providing the predictive model to predict growth efficiency in an animal from the same group and not selected for the sample population comprises the steps of:
f) scanning the animal from at least one view to obtain at least one thermographic image of the animal, whereby each image is represented as an array of pixels providing temperature data representative of temperature information at the corresponding part of the image;
g) calculating a value of at least one statistical measure of the temperature data for each image, wherein the value is treated as an input variable; and
h) solving the predictive model to provide the value of the growth efficiency of the animal.

4. The method according to claim 2, wherein the predictive model is selected from the group consisting of:
(1) GE=fn (1/IRTn), wherein GE represents the growth efficiency and IRTn represents the statistical measure of the temperature data divided by metabolic body size;
(2) (ADG/FI)=fn (1/IRT);
(3) ADG=fn (1/IRT, FI); and
(4) FI=fn (IRT, 1/ADG);
wherein ADG represents average daily weight gain, FI represents feed intake and IRT represents the statistical measure of the temperature data divided by metabolic body size.

5. (canceled)

6. The method according to claim 4, wherein the image view is selected from a dorsal, lateral, distal, ventral and frontal view or combination of the views of the animal.

7. The method according to claim 6, wherein the statistical measures are selected from the group consisting of a measure of central tendency, a measure of dispersion, and a total temperature.

8. The method according to claim 7, wherein other input variables from the animal not derived from the infrared thermography are included in the predictive model.

9. The method according to claim 8, wherein the other input variables are selected from the group consisting of live weight, compositional data, feed consumption, sex, average fat, carcass yield, conformation or body scores, cuttability, grade fat, lean body mass, lean yield, muscle score, rib eye area, and US fat.

10. The method according to claim 8, wherein the other output variables from the animal not derived from the infrared thermography are included in the predictive model.

11. The method according to claim 10, wherein the other output variables are selected from the group consisting of growth efficiency, quantity of accumulated tissue and quantity of feed resource.

12. The method according to claim 10, wherein the animal is selected from the group consisting of swine, horses, cattle, bison, sheep, lamb, deer, moose, elk, caribou, goats, chickens, turkeys, geese, ducks, and game birds.

13. The method according to claim 12, wherein the animal is of the species Sus domesticus.

14. The method according to claim 12, wherein the animal is of the species Bos taurus or Bos indicus.

15. The method according to claim 12, wherein the animal is in a steady-state condition.

16. The method according to claim 12, wherein the animal is in a growth phase.

17. An apparatus for predicting the growth efficiency of an animal, with the apparatus comprising:
a) image acquisition means for scanning the animal from at least one view to obtain at least one infrared thermographic image of the animal, whereby each image is represented as an array of pixels providing temperature data representative of temperature information at the corresponding part of the image; and
b) computing and storing means for:
(i) storing each image as an array of pixels providing temperature data representative of temperature information at the corresponding part of the image;
(ii) calculating a value of at least one statistical measure of the temperature data for each thermographic image;
(iii) providing a predictive model according to any one of claims 4-5, whereby growth efficiency is treated as an output variable, and the statistical measure of temperature data is treated as an input variable; and
(iv) solving the predictive model to provide the value of growth efficiency; and,
(v) output means for furnishing the value of growth efficiency for the animal.

18-25. (canceled)

26. The method according to claim 4, wherein providing the predictive model to predict growth efficiency in an animal from the same group and not selected for the sample population comprises the steps of:
scanning the animal from at least one view to obtain at least one thermographic image of the animal, whereby each image is represented as an array of pixels providing temperature data representative of temperature information at the corresponding part of the image;
calculating a value of at least one statistical measure of the temperature data for each image, wherein the value is treated as an input variable; and
solving the predictive model to provide the value selected from the group consisting of:
i) the value of growth efficiency to detect an animal displaying a high growth efficiency, to select a sire or a dam with high growth efficiency, to determine a feed input which contributes to growth efficiency in an animal, or to assess a group of animals with similar growth efficiencies;
ii) the reciprocal value of growth efficiency of an animal from the group of animals not selected for the sample population to determine an undesirable feed input; and
(v) the value of growth efficiency of the animal from the group of animals
not selected for the sample population to decrease variation in marketing outcomes by grouping animals with high growth efficiency, to utilize a growing-finishing diet for animals in a group by grouping animals with high growth efficiency, or to determine differences in animal growth or energy retention-expenditure rates independent of efficiencies.
